(19) United States
(12) Patent Application Publication
(10) Pub. No.: US 2008/0136141 A1
(43) Pub. Date: Jun. 12, 2008

(54) Snap-on Guide Loop Assembly

(75) Inventor: Mark F. Gray, Sterling Heights, MI (US)

Correspondence Address: FITCH EVEN TABIN AND FLANNERY, 120 SOUTH LA SALLE STREET, SUITE 1600, CHICAGO, IL, 60603-3406, US

(73) Assignee: TK Holdings, Inc., Auburn Hills, MI (US)

(21) Appl. No.: 11/609,536

(22) Filed: Dec. 12, 2006

(51) Int. Cl. B60R 22/24

(52) U.S. Cl. 280/727

(57) ABSTRACT

A guide loop device for a seat belt of a vehicle includes a guide loop having an opening, a mounting stud, and a body. The opening is for receiving the seat belt. The mounting stud is attached to the guide loop and extends therefrom. The body has a substantially solid construction and a portion of the mounting stud is embedded therein.

### FIELD OF THE INVENTION

The present invention relates to a seat belt guide loop assembly and, more particularly, a seat belt guide loop assembly for attaching to a component of a passenger vehicle.

### BACKGROUND OF THE INVENTION

Typical seat belt guide loop assemblies for passenger vehicles can be categorized as either fixed assemblies or adjustable assemblies. A conventional fixed guide loop assembly includes a steel plate, a threaded fastener, and a cover. The steel plate includes an opening and an aperture. The opening receives and supports a seat belt. The aperture receives the threaded fastener. The threaded fastener is typically a bolt that threadingly engages a bore disposed in a component of the vehicle such as the B-pillar. The bolt therefore fixes the guide loop assembly in one position on the B-pillar. The cover attaches to either or both of the steel plate and the threaded fastener to enhance the aesthetic appeal of the guide loop assembly and provide some level of impact protection.

Alternatively, a conventional adjustable guide loop assembly includes a steel plate, a threaded fastener, a height adjustment mechanism, and a cover. Identical to the fixed guide loop assembly described above, the steel plate includes an opening for receiving a seat belt and an aperture for receiving the threaded fastener. The height adjustment mechanism is slidably attached to a component of the vehicle such as the B-pillar. In one form of the conventional adjustable guide loop assembly, the height adjustment mechanism is independent of the steel plate and the two are attached via the threaded fastener. In another form of the conventional adjustable guide loop assembly, the height adjustment mechanism is integral with the steel plate and the threaded fastener attaches the pair to a component of the vehicle such as the B-pillar. In either configuration, the height adjustment mechanism generally includes a guide rail, a locking pin, a biasing member, and an actuator button. The guide rail is fixedly attached to the B-pillar of the vehicle and includes a plurality of longitudinally aligned locking apertures. The locking pin includes a steel pin that is moveable between an extended locked position and a retracted unlocked position. The biasing member typically includes a spring biasing the locking pin into the extended locked position. While in the extended locked position, the locking pin is disposed within one of the plurality of locking apertures of the guide rail. The actuator button may be manipulated to move the locking pin to the retracted unlocked position allowing a passenger to adjust the position of the guide loop assembly relative to the vehicle. Finally, similar to the fixed guide loop assembly, the cover attaches to any one or combination of the steel plate, th threaded fastener, and the height adjustment mechanism to enhance the aesthetic appeal of the guide loop assembly and provide some level of impact protection.

While guide loop assemblies having either of the above-described configurations have proved structurally effective, fixing the threaded fastener to the B-pillar of the vehicle requires considerable time and cost. First, an assembly technician or robotic arm must properly align the threads of the fastener with the threads of the corresponding bore. This often requires the technician or robotic arm to enter the vehicle through the door or window opening. A tool such as a torque wrench must then be used to tighten the threaded fastener and ensure that the assembly will withstand a typical tensile load experienced during a collision or similar event. Due to the time, cost, and space constraints on automobile assembly plants, it can be cumbersome and time-consuming for a technician or robotic arm to perform these tasks, which ultimately increases the costs.

Another concern with the conventional guide loop assemblies described above pertains to the mounting of the cover. As stated above, the cover is adapted to attach to at least one component of the assembly to enhance its aesthetic appeal, as well as provide some level of impact protection. Often times, the cover becomes disengaged from the assembly, thereby exposing the head of the threaded fastener. In this situation, the conventional guide loop assembly lacks the designed aesthetic appeal and impact protection.

### SUMMARY OF THE INVENTION

In accordance with one form of the present invention, a guide loop device for a seat belt of a vehicle includes a guide loop having an opening, a mounting stud, and a body. The opening is for receiving the seat belt. The mounting stud extends from the body. The body has a substantially solid construction and a portion of the mounting stud is embedded therein.

An advantage of this device is that it increases the efficiency of assembly. The exposed end of the mounting stud need only be inserted into a locking bore disposed on a component of the vehicle. Additionally, because the guide loop assembly is prefabricated as a single structure, assembly of the guide loop, the threaded fastener, and the cover of the conventional guide loop on the assembly line is eliminated. Furthermore, the cover in which the mounting stud is embedded ensures appropriate maintenance of the guide loop assembly's aesthetic appeal and impact protection.

According to another form, the body of the guide loop assembly includes a plate of metallic material and the cover includes molded material on the plate.

According to another form, the mounting stud includes an enlarged head that is permanently fixed to the plate of the body.

According to another form, the plate of the body includes an aperture and the enlarged head of the mounting stud is fixed to the plate adjacent the aperture.

According to another form, the body of the guide loop has an upper mounting portion and a lower seat belt guide portion. The upper mounting portion substantially lacks any voids. The mounting stud is embedded in the upper mounting portion. The lower seat belt guide portion has an annular configuration forming a seat belt opening.

According to another form, the mounting stud has a free end portion that projects from the body. The free end portion is configured for snap-fit engagement with the vehicle.

According to another form, the guide loop device further includes a resilient member operably attached to the vehicle. The resilient member is configured for cooperating with the free end portion of the mounting stud for snap-fit engagement therewith.

According to another form, the guide loop device further includes an adjustment mechanism. The adjustment mechanism is slidably attached to the vehicle for adjusting a position of the guide loop relative thereto.

According to another form, the adjustment mechanism includes an actuator. The actuator enables an operator to selectively lock the adjustment mechanism in one of a plurality of positions relative to the vehicle.

### BRIEF DESCRIPTION OF THE DRAWINGS

FIG. 1 is a cabin-side perspective view of a guide loop assembly according to one form of the present invention showing a guide loop, a height adjustment mechanism, and a guide rail attached to a component of a passenger vehicle such as a B-pillar of an automobile;

FIG. 2 is a mounting-side perspective view of a guide loop assembly according to one form of the present invention detached from the vehicle and showing a slide plate mounted to the guide rail and a locking pin of the height adjustment mechanism engaging one of a plurality of openings in the guide rail for locking the guide loop assembly thereto;

FIG. 3 is a cross-sectional side view of a guide loop assembly according to one form of the present invention showing the guide loop having a mounting stud, a plate, and a cover, wherein the mounting stud is snap-fittingly engaged with a resilient member of the height adjustment mechanism;

FIG. 4 is a partially exploded cross-sectional side view of the guide loop assembly of FIG. 3 showing the guide loop, the guide rail, and the height adjustment mechanism including a housing, the resilient member, and the locking pin independently disposed relative to each other; and

FIG. 5 is a fragmented cross-sectional side view of a guide loop assembly according to an alternative form of the present invention showing a guide loop having a mounting stud fixed to a guide loop member, wherein the mounting stud is snap-fittingly engaged with a resilient member of the height adjustment mechanism.

### DETAILED DESCRIPTION OF THE PREFERRED EMBODIMENTS

Hereinafter, forms of the present invention will be described in detail with reference to the drawings.

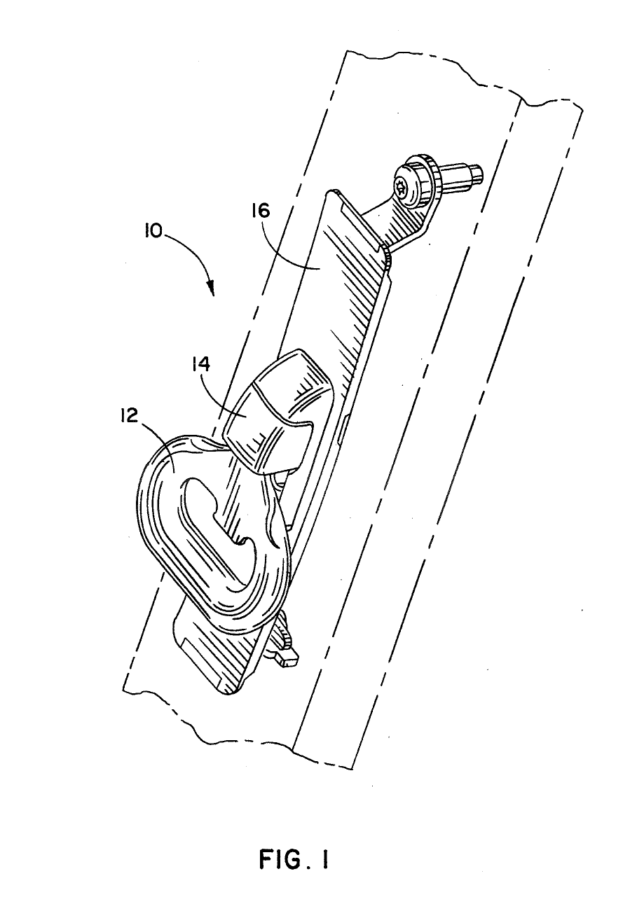

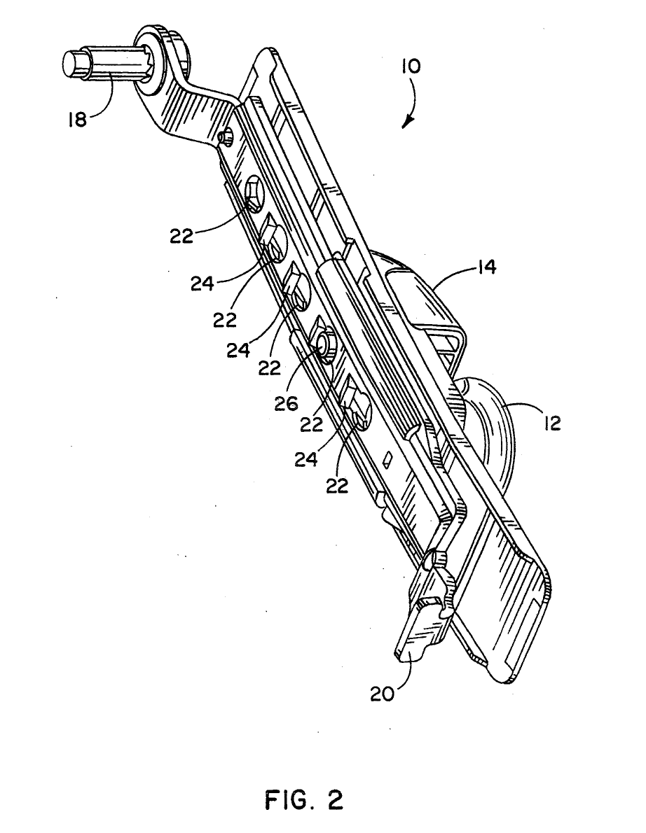

FIGS. 1-4 generally depict a guide loop assembly 10 according to one form of the present invention including a guide loop 12, a height adjustment mechanism 14, and a support rail 16. FIG. 1 depicts the guide loop assembly 10 attached to a component of a passenger vehicle such as a B-pillar of an automobile, which is shown in phantom. The guide loop 12 is adapted to receivingly support seat belt webbing and is attached to the height adjustment mechanism 14. The height adjustment mechanism 14 is slidably mounted to the support rail 16 (shown in more detail in FIG. 2) and is adapted for selective displacement between a plurality of positions relative thereto. The support rail 16 is fixed to the B-pillar of the automobile.

FIG. 2 illustrates a backside of the guide loop assembly 10 and, more specifically, a backside of the support rail 16. The support rail 16 includes a fastener 18, a lock clip 20, a plurality of openings 22, and a plurality of ramped tabs 24. In one form, the fastener 18 includes a threaded fastener or bolt in threading engagement with a bore (not shown) in the B-pillar and the lock clip 20 is lockingly disposed in an opening (not shown) in the B-pillar to secure the support rail 16 thereto. The height adjustment mechanism 14 includes a locking pin 26, shown in FIG. 2 in selective engagement with one of the openings 22. This locks the guide loop assembly 10 and prevents it from displacing relative to the support rail 16. As will be described in more detail below, the locking pin 26 of the height adjustment mechanism 14 can be manipulated by a vehicle occupant to enable adjustment of the guide loop assembly 10 to obtain a comfortable seat belt arrangement.

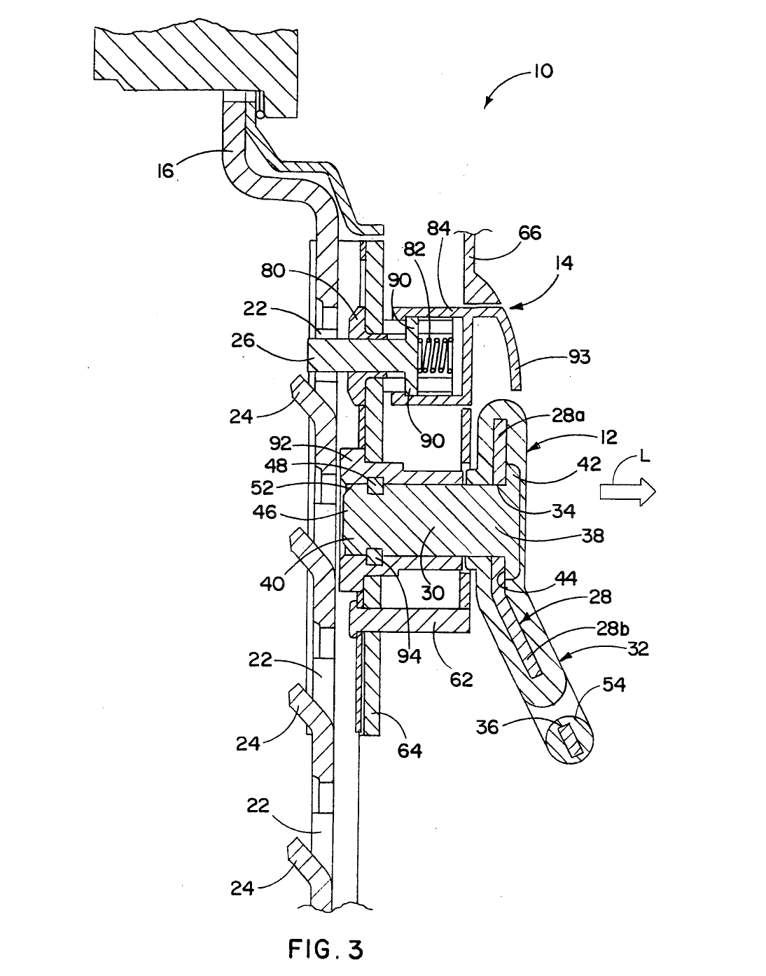

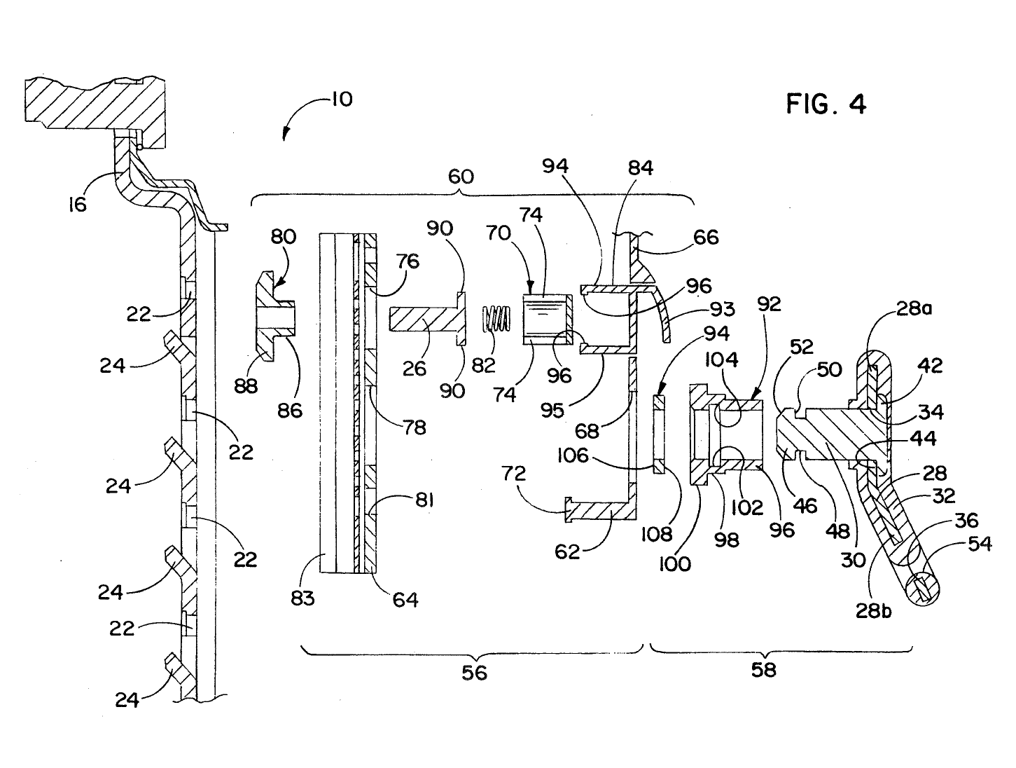

With specific reference to FIGS. 3 and 4, one form of the guide loop 12 includes a plate member 28, a mounting stud 30, and a cover 32. The plate member 28 is generally flat and includes an upper portion 28a and a lower portion 28b disposed at a slight angle relative to each other. The upper portion 28a includes a circular aperture 34. The lower portion 28b includes a generally oblong opening 44. The mounting stud 30 includes a proximal portion 38 and a distal portion 40. The proximal portion 38 includes an enlarged head 42 having an abutment surface 42. The distal portion 40 includes a nose 46 and an annular recess 48. The annular recess 48 is disposed between the nose 46 and the proximal portion 38 of the mounting stud 30 and includes an engagement surface 50 (shown more clearly in FIG. 4). The nose 46 is generally bullet-shaped and has a chamfered shoulder surface 52. The annular recess 48 has a generally square cross-section. It should be appreciated, however, that in an alternate form, the nose 46 may include a rounded shoulder surface 52 and the annular recess 48 may include a cross-section other than generally square such as rectangular, trapezoidal, triangular, or any other shape capable of serving the principles of the present invention.

The cover 32 of the guide loop 12 is an integral member enclosing the plate member 28 and the proximal portion 38 of the mounting stud 30. The cover 32 includes a generally oblong seat belt opening 54 disposed substantially coaxial with the aperture 34 in the lower portion 28b of the plate member 28. In one form, the plate member 28 and the mounting stud 30 are constructed of a rigid material such as steel and the cover 32 is constructed of a semi-rigid to rigid moldable material such as a polymer, a copolymer, or some other similar material capable of serving the principles of the present invention. During manufacture, the mounting stud 30 is disposed in the aperture 34 of the plate member 28 and the cover 32 is formed around the two components. In one form, the cover 32 is formed by injection molding. It should be appreciated that the opening 54 in the cover 32 includes soft rounded internal surfaces for accommodating the seat belt webbing without damaging the seat belt webbing.

As shown in FIG. 3, the proximal portion 38 of the mounting stud 30 is disposed in the aperture 34 of the plate member 28. The abutment surface 44 of the enlarged head 42 of the mounting stud 30 abuttingly engages the upper portion 28a of the plate member 28 directly adjacent the aperture 34. This abutment laterally locates the mounting stud 30 relative to the plate member 28. The cover 32 is disposed completely around the upper portion of the plate member 28. Additionally, the proximal portion 38 of the mounting stud 30, which engages the plate member 28, is embedded in the cover 32. So configured, the cover 32, the mounting stud 30, and the upper portion 28a of the plate member 28 form a substantially solid member lacking any considerable voids. In one form, the cover 32 retains the mounting stud 30 in the plate member 28. In another form, the mounting stud 30 press-fittingly engages the aperture 34 in the plate member 28 to retain the mounting stud 30 therein.

With continued reference to FIGS. 3 and 4, one form of the height adjustment mechanism 14 includes a housing 56, a snap-fit assembly 58, and a locking mechanism 60, shown generally in FIG. 4. The housing 56 forms a generally box-shaped container including a raised member 62 and a guide plate 64. The housing 56 contains the snap-fit assembly 58 and the locking mechanism 60. The raised member 62 includes a top plate 66, a mounting aperture 68, an internal housing protrusion 70, and a stop clip 72. The internal housing protrusion 70 is a hollow, substantially cylindrical member defining a substantially cylindrical cavity and having opposing axially extending slots 74. The guide plate 64 is a generally flat plate in cooperative engagement with the raised member 62. The guide plate 64 includes a locking aperture 76, a mounting aperture 78, an opening 81, and opposing longitudinal side rails 83 (shown in FIGS. 3 and 4). The locking aperture 76 is substantially coaxially aligned with the cavity of the internal housing protrusion 70 of the raised member 62. The mounting aperture 78 is substantially coaxially aligned with the mounting aperture 68 of the raised member 62. The opposing longitudinal side rails 83 slidingly receive corresponding longitudinal side edges of the support rail 16. The cavity defined by the internal housing protrusion 70 operably contains the locking mechanism 60 in cooperation with the locking aperture 76 of the guide plate 64. The mounting aperture 68 in the raised member 62 contains the snap-fit assembly 58 in cooperation with the mounting aperture 78 in the guide plate 64.

The locking mechanism 60 includes a spring-biased locking mechanism disposed in the cylindrical cavity defined by the internal housing protrusion 70 of the raised member 62 of the housing 56 and the locking aperture 70 of the guide plate 64. More specifically, the locking mechanism 60 includes a bushing 80, the locking pin 26, a biasing member 82, and an actuator 84. The bushing 80 is a hollow, generally cylindrical metallic member including a cylindrical body portion 86 and a radial flange 88. An outer radial surface of the cylindrical body portion 86 press-fittingly engages an inner radial surface of the locking aperture 76 of the guide plate 64. The radial flange 88 abuttingly engages a surface of the guide plate 64 adjacent the locking aperture 76 and opposite the raised member 62 of the housing 56. The pin 26 is a metallic, generally cylindrical member having a cylindrical body and a pair of opposing tabs 90 extending radially therefrom. The cylindrical body is slidably disposed between an extended locked position (shown in FIG. 3) and a retracted unlocked position (not shown). The opposing tabs 90 are slidably disposed in the slots 74 of the internal housing protrusion 70 of the raised member 62 of the housing 56. The opposing tabs 90 extend radially beyond an outer cylindrical wall of the internal housing protrusion 70 and are adapted to be engaged by the actuator 84, as shown in FIG. 3. The biasing member 82 includes a coil spring disposed in the cavity of the internal housing protrusion 70. The biasing member 82 is disposed between the locking pin 26 and the top plate 66 of the raised member 62 of the housing 56 and biases the locking pin 26 in the extended locked position, which is shown in FIG. 3. FIG. 3 also shows the actuator 84 including a manually graspable handle 93 with arm portions 95 extending into the raised member 62 of the housing 56. The arm portions 95 further include finger portions 96 adapted for operable engagement with the tabs 90 of the locking pin 26. The actuator 84 is adapted to be pulled away from the raised member 62 of the housing 56 to engage the tabs 90 of the locking pin 26 and apply a force against the bias of the biasing member 82. A continued application of force displaces the locking pin 26 to the retracted unlocked position (not shown), wherein the locking pin 26 disengages the opening 22 in which it is disposed in the support rail 16.

The snap-fit assembly 58 includes a lock bushing 92 and a resilient locking member 94. The lock bushing 92 is a hollow, generally cylindrical metallic member including a cylindrical body portion 96, a radial shoulder 98, a radial flange 100, and an internal annular recess 102. The lock bushing 92 is disposed such that the cylindrical body portion 96 is disposed within the housing 56 and an outer radial surface of the radial shoulder 98 press-fittingly engages an inner radial surface of the mounting aperture 78 in the guide plate 64. This maintains the lateral disposition of the lock bushing 92 relative to the housing 56. The radial flange 100 abuttingly engages a surface of the guide plate 64 adjacent the mounting aperture 78 and opposite the raised member 62 of the housing 56. This maintains the axial disposition of the lock bushing 92 relative the housing 56. The internal annular recess 102 has a generally square cross-section including an engaged surface 104.

The resilient locking member 94 is a metallic, generally ring-shaped member having a first retainer surface 106 and a second retainer surface 108. An outer radial portion of the locking member 94 is disposed in the internal annular recess 102 of the lock bushing 92 and an inner radial portion is disposed in the annular recess 48 of the mounting stud 30. The resilient locking member 94 serves to maintain the guide loop 12 in attachment with the housing 56 upon the application of a tensile load thereto. For example, during a collision or abrupt stop of the automobile, a tensile load is applied to the mounting stud 30 in a direction identified by the arrow L in FIG. 3. This causes the engagement surface 50 of the annular recess 48 of the mounting stud 30 to engage the first retainer surface 106 of the resilient locking member 94. In turn, the second retainer surface 108 of the resilient locking member 94 engages the engaged surface 104 of the lock bushing 92. Ultimately, the engagement between the radial flange 100 of the lock bushing 92 and the guide plate 64 adjacent the mounting aperture 78 therein secures the guide loop 12 within the snap-fit assembly 58 during such tensile loading.

During assembly, the height adjustment mechanism 14 of the above-described form of the guide loop assembly 10 is preassembled onto the support rail 16. Therefore, on the assembly floor, the support rail 16 must be mounted to a component of a passenger vehicle and the guide loop 12 fixed thereto. As stated above, in one form, the component includes the B-pillar of an automobile. In the form illustrated, the support rail 16 is mounted to the B-pillar with the combination of the threaded fastener 18 and lock clip 20 depicted in FIG. 2. However, it should be appreciated that alternate forms of fixing the support rail 16 to the B-pillar are intended to be within the scope of the present invention. For example, a rivet, a screw, or any other foreseeable fastening device may be utilized. Once the support rail 16 is securely fixed to the B-pillar, seat belt webbing is fed through the seat belt opening 54 in the guide loop 12. Finally, the mounting stud 30 of the guide loop 12 is inserted through the mounting aperture 68 in the raised member 62 of the housing 56 and into locking engagement with the snap-fit assembly 58. More specifically, the chamfered shoulder surface 52 of the nose 46 of the mounting stud 30 abuts the inner radial portion of the resilient locking member 94. Upon a continued application of force to the mounting stud 30 in a direction opposite to the arrow L depicted in FIG. 3, the resilient locking member 94 elastically deforms to allow the nose 46 of the mounting stud 30 to pass therethrough. Once the nose 46 passes the resilient locking member 94, the resilient locking member 94 elastically returns to its original configuration lockingly disposed in the annular recess 48 in the mounting stud 30. The resilient locking member 94 thereby securely fixes the mounting stud 30 and ultimately the guide loop 12 to the height adjustment mechanism 14. It should be appreciated that while the above-described guide loop assembly 10 includes the guide loop 12 fixed to the height adjustment mechanism 14, which is fixed to the B-pillar of the automobile, it is envisioned that the height adjustment mechanism 14 could be eliminated from the guide loop assembly 10. So configured, it is envisioned that the B-pillar of the automobile may include a mounting bore that directly accommodates the snap-fit assembly 56 including the resilient locking member 94 into which the mounting stud 30 locks. While this alternative configuration is not directly depicted herein, it is intended to be within the scope of the claims of the present invention.

Therefore, once the guide loop assembly 10 is properly mounted to the automobile, the biasing member 82 of the locking mechanism 60 biases the locking pin 26 into the extended locked position and into engagement with one of the openings 22 in the support rail 16. This prevents the guide loop assembly 10 from inadvertently displacing relative to the vehicle. It should be appreciated however, that the above-described assembly enables the occupant to selectively adjust the height of the guide loop 12. To adjust the position of the guide loop 12, the occupant grasps the actuator 84 and pulls it toward the inside of the vehicle cabin in the direction of the arrow L depicted in FIG. 3. This causes the finger portions 96 of the arms 94 of the actuator 84 to axially engage the tabs 90 of the locking pin 26 to displace the locking pin 26 against the bias of the biasing member 82 and out of engagement with the opening 22 in the support rail 16. At this point, the occupant is free to slide the height adjustment mechanism 14 and guide loop 12 up or down along the support rail 16. Once an approximate location for the guide loop 12 is reached, the occupant may release the actuator 84. Upon release of the actuator, the biasing member 82 biases the locking pin 26 toward the extended locked position. If the locking pin 26 is aligned with one of the openings 22 in the support rail 16, it engages the corresponding opening 22 and locks the guide loop assembly 10. Alternatively, if upon release of the actuator 84, the locking pin 26 is not aligned with an opening 22 in the support rail 16, but rather one of the plurality of ramped tabs 24 adjacent one of the openings 22, the slope of the ramped tab 24 will receive the locking pin 26 and act to bias the guide loop assembly 10 upward in FIG. 3 until the locking pin 26 aligns with the corresponding opening 22. This eliminates the need for the occupant to exactly align the locking pin 26 with an opening 22 prior to releasing the actuator 84. Further yet, if upon release of the actuator 84, the locking 26 aligns with a flat surface between adjacent openings 22 in the support rail 16, the occupant need only displace the guide loop assembly 10 slightly up or down to align the locking pin 26 with an opening 22.

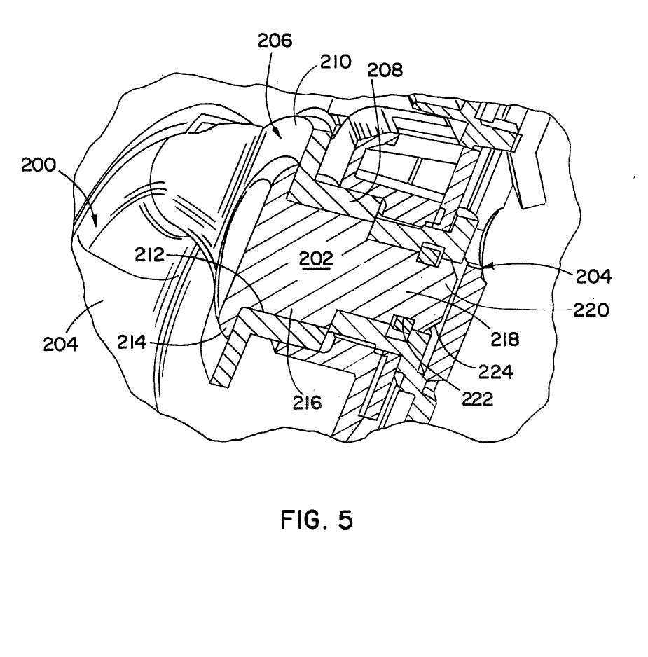

FIG. 5 depicts a guide loop 200 and a mounting stud 202 according to an alternate form of a guide loop assembly according to the present invention. It should be appreciated that the guide loop 200 and mounting stud 202 depicted in FIG. 5 are cooperatively connected to a snap-fit assembly 204 very similar to that described above and, therefore, the structure of the snap-fit assembly depicted in FIG. 5 will not be discussed herein in detail. Additionally, it should be appreciated that the guide loop 200 and the mounting stud 202 depicted in FIG. 5 are adaptable to an entire guide loop assembly similar to that discussed above and, therefore, to eliminate repetition, the discussion here is limited to these specific components.

The guide loop 200 is a generally ring-shaped metallic member having a supporting portion 204 and a mounting portion 206. The supporting portion 204 is generally C-shaped for receivingly supporting seat belt webbing. The mounting portion 206 includes a collar portion 208 and a washer portion 210 defining a mounting bore 212. The mounting collar portion 208 is a substantially cylindrical member coaxially aligned with the mounting bore 212. The collar portion 208 extends substantially perpendicular to the washer portion 210. The mounting stud 202 is an elongated steel member having a head portion 214, a shoulder portion 216, and a locking portion 218. The head portion 214 has a diameter larger than a diameter of the shoulder portion 216. The shoulder portion 216 has a diameter larger than a diameter of the locking portion 218. The locking portion 218 includes a nose 220 and an annular recess 222. The nose 220 includes a chamfered engagement surface 224. The annular recess 222 is disposed axially between the nose 220 and the shoulder portion 216.

In the form illustrated, the head portion 214 of the mounting stud 202 abuttingly engages a surface of the washer portion 210 opposite the collar portion 216. This abutment locates the mounting stud 202 relative to the guide loop 200. The shoulder portion 216 of the mounting stud 202 is press-fit into the mounting bore 212. This securely fixes the mounting stud 202 to the guide loop 200. The annular recess 222 in the mounting stud 202 includes a substantially square cross-section. So configured, the assembly of the guide loop 200 and mounting stud 202 depicted in FIG. 5 to the snap-fit assembly is very similar to the assembly of the guide loop assembly 10 discussed above and depicted in FIGS. 1-4. Specifically, the mounting stud 202 is inserted into the snap-fit assembly 204 such that the resilient member lockingly engages the annular recess 222 therein. Thus, it should be appreciated that the form of the invention illustrated in FIG. 5 is very similar to that illustrated in FIGS. 1-4, but for the absence of a cover. Rather, the head portion 214 of the mounting stud includes a rounded head in abutment with the washer portion 210 of the guide loop 200. This provides a finished surface that may be desirable in industrial or performance applications, wherein aesthetics may not necessarily play such an important role.

Additionally, it should be appreciated that the foregoing merely discloses and describes examples of forms of the present invention. One skilled in the art will readily recognize from such description, and from the accompanying drawings and claims, that various changes, modifications and variations may be made without departing from the spirit and scope of the invention.

What is claimed is:

1. A guide loop device for a seat belt of a vehicle, the guide loop device comprising:
a guide loop having an opening for the seat belt;
a mounting stud of the guide loop; and
a body of the guide loop having a substantially solid construction with a portion of the mounting stud embedded therein.

2. The guide loop device of claim 1, wherein the body includes a plate of metallic material and molded material on the plate.

3. The guide loop device of claim 2, wherein the mounting stud includes an enlarged head substantially permanently fixed to the plate of the body.

4. The guide loop device of claim 3, wherein the plate of the body includes an aperture and a portion of the mounting stud adjacent the enlarged head is disposed in the aperture.

5. The guide loop device of claim 1, wherein the body of the guide loop has an upper mounting portion substantially lacking any voids in which the mounting stud is embedded and a lower seat belt guide portion having an annular configuration to form the seat belt opening.

6. The guide loop device of claim 1, wherein the mounting stud has a free end portion projecting from the guide loop body that is configured for snap-fit engagement with the vehicle.

7. The guide loop device of claim 6, further comprising a resilient member operably attached to the vehicle and configured for cooperating with the free end portion of the mounting stud for snap-fit engagement therewith.

8. The guide loop device of claim 1, further comprising an adjustment mechanism slidably attached to the vehicle for displacing the guide loop relative thereto and engaged with the mounting stud.

9. The guide loop device of claim 8, wherein the adjustment mechanism includes an actuator for selectively locking the adjustment mechanism in one of a plurality of positions relative to the vehicle.

10. A guide loop device for a seat belt of a vehicle, the guide loop device comprising:
a guide loop member having an opening for receiving the seat belt;
a mounting stud extending from the guide loop member;
a resilient member operably attached to the vehicle and configured for cooperative engagement with the mounting stud.

11. The guide loop device of claim 10, wherein the resilient member is a resilient ring adapted for snap-fit engagement with the mounting stud.

12. The guide loop device of claim 10, further comprising an adjustment mechanism supporting the resilient member and slidably attached to the vehicle for selective displacement relative thereto.

13. The guide loop device of claim 10, further comprising a cover disposed about the guide loop member and at least a portion of the mounting stud such that the cover, the guide loop member and the mounting stud form a substantially solid component.

14. An anchor device for a seat belt of a vehicle, the anchor device comprising:
a guide loop member having an opening for receiving a seat belt;
a mounting stud extending from the guide loop member;
a cover disposed about the guide loop member and at least a portion of the mounting stud such that the cover, the guide loop member and at least the portion of the mounting stud form a substantially solid component; and
an adjustment mechanism operably mounted to the vehicle to allow selective adjustment of the guide loop member relative to the vehicle, the adjustment mechanism supporting a resilient member configured for cooperative engagement with the mounting stud.

15. The anchor device of claim 14, wherein the mounting stud is fixedly attached to the guide loop member.

16. The anchor device of claim 14, wherein the guide loop member includes an aperture receiving the mounting stud and the mounting stud includes a flange in abutment with the guide loop member adjacent the aperture.

17. The anchor device of claim 14, wherein the resilient member includes a resilient ring-shaped member.

18. The anchor device of claim 14, wherein the adjustment mechanism includes an actuator for selectively locking the adjustment mechanism in one of a plurality of positions relative to the vehicle.
